(19) United States
(12) Patent Application Publication
(10) Pub. No.: US 2002/0091562 A1
(43) Pub. Date: Jul. 11, 2002

(54) Facilitating offline and online sales

(75) Inventors: Brian M. Siegel, Washingtonville, NY (US); Philip M. Abram, Warwick, NY (US); Marc Beckwitt, San Clemente, CA (US); Gregory D. Gudorf, Mahwah, NJ (US); Kazuaki Iso, Oradell, NJ (US); Brian Raymond, San Diego, CA (US); Christopher M. Tobin, McLean, VA (US)

Correspondence Address: WOOD, HERRON & EVANS, L.L.P., 2700 Carew Tower, Cincinnati, OH, 45202, US

(73) Assignee: Sony Corporation and Sony Electrics Inc.

(21) Appl. No.: 09/871,716

(22) Filed: Jun. 1, 2001

Related U.S. Application Data
(60) Provisional application No. 60/208,845, filed on Jun. 2, 2000.

(51) Int. Cl. G06F 17/60

(52) U.S. Cl. 705/10

(57) ABSTRACT

A customer maintains an Electronic Information Account (EIA) on a data storage device, such as on a portable electronic device (e.g., personal digital assistant) or on a nonvolatile memory device (e.g., smart card, memory stick). On the storage device, the EIA includes a customer profile and transaction records for later reference and for selective electronic communication to merchants and sources of goods or services for purposes of speeding a transaction, suggesting future purchases based on prior transactions, confirming product warranty registration, and limiting transactions for subordinate customers. Comprehensive capturing of transaction records is provided by synchronizing the data stored on the customer data storage device and on a remotely stored duplicate customer profile and database of transaction records.

### CROSS REFERENCE TO RELATED APPLICATIONS

This application claims the benefit of, and hereby incorporates by reference in its entirety, the commonly owned U.S. Provisional Application, Serial No. 60/208,845, that was filed on Jun. 2, 2000 by Brian Siegel, Philip M. Abram, Marc Beckwitt, Gregory D. Gudorf, Brian Raymond, and Christopher M. Tobin: entitled “BUSINESS PROCESS FOR FACILITATING OFFLINE SALES FROM ONLINE EVENTS.”

### FIELD OF THE INVENTION

The present invention relates to a customer-controlled system for record keeping of transactions and identifying information for selective electronic communication to sources of goods and services, whether the transaction occurs at an off-line retail store or at an on-line site.

### BACKGROUND OF THE INVENTION

Customers increasingly use electronic financial accounts such as credit cards, debit cards, and electronic financial checks to perform a variety of purchase transactions for goods and services. These electronic accounts facilitate retail purchases across geographic distances, including across electronic communication methods such as the telephone system and the Internet.

Financial institutions that provide such electronic accounts offer additional services to merchants and to the customers of the electronic accounts. For example, the customer may view their previous transaction history over an on-line display. As another example, the financial institution may perform “data mining”, characterizing the purchase tendencies of the customer for use by manufacturers and retailers to direct targeted advertising to the customer.

These financial institutions build in usage limitations to reduce credit fraud and abuse. Specifically, the pattern of purchases is monitored to identify instances that are not characteristic, warranting verification whether another person has stolen the charge number for the electronic account. As another example, the financial institution imposes financial credit limits on each account based on the credit worthiness of the customer. For example, the financial institution establishes a relatively low credit limit for a college student with limited income and limited credit history.

Some retail merchants also facilitate purchases with check cashing cards that include identifying information about the customer to speed up a retail transaction. The retail merchant encourages customers to obtain and use the cards by associating coupons or prizes or other inducements. By linking specific customers with purchases of specific products, the retail merchant is able to target specific advertisements to specific customers as well as reducing the likelihood of check fraud due to improperly checked identifying information.

Customers who uses these electronic accounts and check cashing cards often fail to share in the benefits afforded the financial institutions and retail merchants. In particular, customers may prefer to exercise control over the use of identifying information. For instance, a customer may want to limit private information available to third parties that link his identity to his purchases. In other instances, a customer may wish to electronically communicate his identifying information to the retailer or to the original source of the good or service (e.g., product registration for warranty purposes).

In addition, the customer may want to exercise control over the types of transactions that may occur on his electronic account. For example, a parent may provide a credit card to a child who attends a distant university. The parent would like for the child to use the credit card for necessary expenditures like tuition, room and board but not to use the credit card for other types of purchases. As a further example, the parent would like to preclude writing a check for certain types of purchases or for purchases outside of the geographic area of the university. Furthermore, the customer may wish to data mine his own transaction history in order to confirm warranty registrations, for recommendations of future purchases, and for monitoring activities of family members.

Moreover, the customer who prefers to use cash or similar means of payment or who performs transactions both at off-line “bricks and mortar” stores and on-line, finds that electronic accounts do not exist for capturing these different types of transactions. Instead, the customer has to manually sift through paper receipts, handwritten check register entries, or other personally-taken records in order to create a transaction history.

Certain sources of goods and services, such as manufacturers and distributors, may also want to encourage an ongoing relationship with these customers, yet have corresponding limitations. For instance, these sources may not have a presence as a retail merchant, either an off-line store or an on-line site or both. These sources may not act as a financial institution and thus be unable to provide electronic account identifiers such as check cashing cards or credit cards. Instead, these sources of goods and services attempt to communicate with their customers with registration materials included with the product, encouraging the customers to mail in or electronically communicate identifying information. However, the inconvenience of such post-transaction communications tends to limit the level of participation by customers.

Consequently, a significant need exists for a system whereby customers may control and interact with their identifying information and transaction history in conjunction with retail purchases, and for the sources of goods and services to communicate with these customers.

### SUMMARY OF THE INVENTION

The present invention addresses these needs as well as others with a customer data storage device that provides selected identifying information from a customer profile by electronic communication to a merchant and also electronically stores a transaction record for each transaction for later reference by the customer. Having the customer access and transport his customer profile and transaction records (Electronic Information Account or EIA) allows for the customer to engage in transactions through various methods (e.g., on-line, retail store, cash purchases, credit card purchases) yet maintain a unified source of information regarding these transactions.

Consistent with a particular aspect of the invention, a customer data storage device (e.g., smart card, memory stick, program on a personal digital assistant (PDA)) contains the customer profile. During purchase at a retail store or on-line, the customer electronically communicates identifying information to a merchant. For example, the merchant may “swipe” a smart card, reading the customer profile stored on the card. As another example, the customer may activate an infrared communication link from a PDA. Then, a transaction record is electronically stored on the customer data storage device for later uses. The electronic communication of the transaction may advantageously maintain a relationship with a source of goods or services without having to create a direct financial relationship with the source. The interactive relationship benefits the source by increasing sales and benefits the customer by allowing direct and convenient inducements from the source (e.g. warranty registration).

Consistent with another particular aspect of the invention, a remote EIA duplicates at least a portion of the customer profile and transaction records stored on the customer data storage device. For example, a program stored on a network or on the customer's desktop computer captures transactions performed on-line or at a retail establishment when the customer data storage device cannot be updated with a transaction record. At a later time, the customer synchronizes the data storage device with the remote EIA. Thereby, the customer is available to engage in a range of transactions while maintaining the benefits of capturing transaction records.

The above and other objects and advantages of the present invention shall be made apparent from the accompanying drawings and the description thereof.

### BRIEF DESCRIPTION OF THE DRAWING

The accompanying drawings, which are incorporated in and constitute a part of this specification, illustrate embodiments of the invention and, together with a general description of the invention given above, and the detailed description of the embodiments given below, serve to explain the principles of the invention.

FIG. 1 is a generalized block diagram showing a computer system for facilitating off-line and on-line transactions in which the present invention may be implemented;

FIG. 2 generally illustrates a computer usable in the system of FIG. 1;

FIG. 3 is a depiction of Electronic Identification Account (EIA) local storage device incorporated into a smart card used in the computer system of FIG. 1;

FIG. 4 is a data structure of a customer profile, subordinate profiles, and transaction records stored on a customer EIA local storage device and duplicated on a networked system; and

FIG. 5 is a flowchart of a sequence of operations performed by the computer system of FIG. 1.

### DETAILED DESCRIPTION OF SPECIFIC EMBODIMENTS

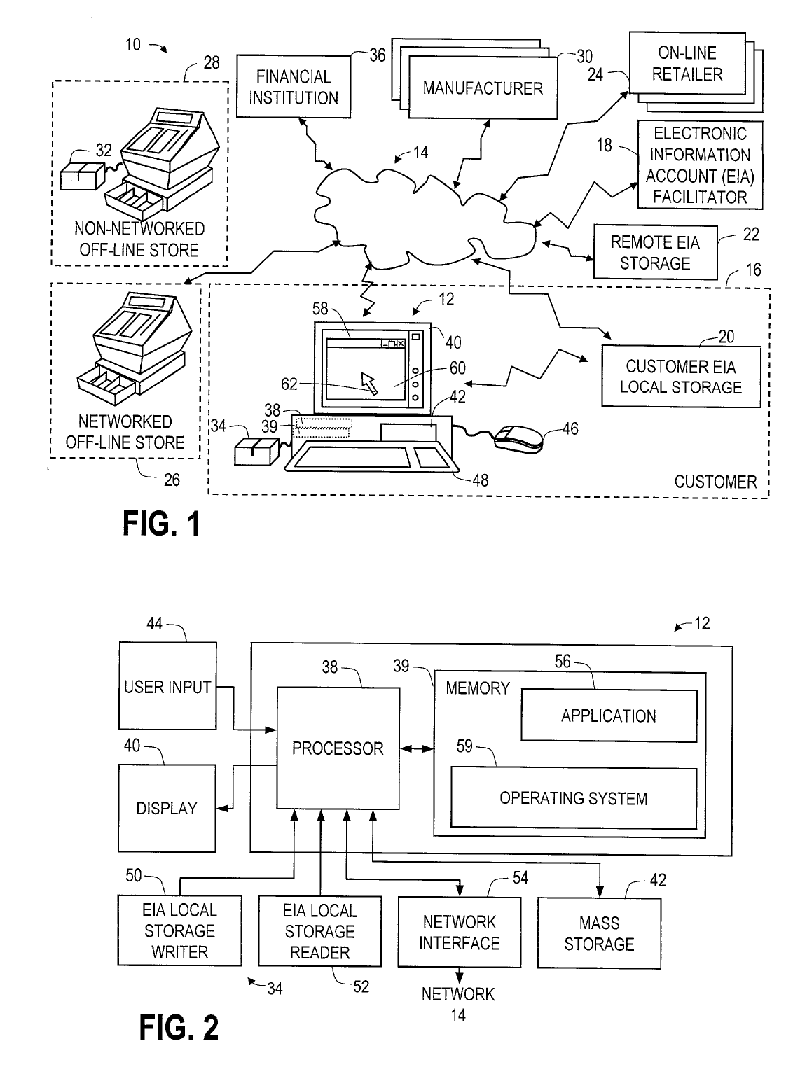

Turning to the Drawings, wherein like numbers denote like parts throughout the several views, FIG. 1 illustrates a computer system 10 consistent with the invention. Computer system 10 is illustrated as a networked computer system including at least one customer computer 12 (e.g., desktop or PC-based computers, workstations, personal digital assistant (PDA), a PC-based server, a minicomputer, a midrange computer, a mainframe computer, etc.) in electronic communication with a network 14. Network 14 may represent practically any type of networked interconnection, including but not limited to local-area, wide-area, wireless, and public networks (e.g., the Internet). Moreover, any number of computers and other devices may be networked through network 14, e.g., multiple servers.

A customer 16 that uses the customer computer 12 has an Electronic Information Account (EIA) assigned by an EIA Facilitator 18. The customer 16 uses the EIA for electronic communication to other parties on the computer system 10 to facilitate transactions such as purchases of goods and services. The EIA includes identifying information (customer profile) and transaction records associated with the transaction history of the customer that are stored both in a customer local EIA storage device 20 and advantageously in a remote EIA storage device 22.

The local and remote EIA storage devices 20, 22 increase the comprehensive nature of the transaction records by capturing transactions made to on-line retailer computers 24 from the customer computer 12 and at off-line retail store computers 26, 28 that may or may not be connected to the network 14. For instance, a local EIA storage device 20 may be portable, in the form of a card bearing a magnetic strip, a smart card including nonvolatile memory, FLASH memory card, or a PDA incorporating an EIA program and wireless communication capability. The customer 16 presents the EIA local storage device 20 to a merchant at the time of purchase. For a networked off-line store computer 26, a transaction record is communicated to the remote EIA storage device 22. The transaction record may then be forwarded, as set up by the customer 16, to other parties such as a source of the good or service, depicted as manufacturer computer 30. Thereby, the customer registers the transaction for warranty, participation in purchase incentive programs, etc. The remote EIA storage device 22 may also serve as an archive for the local EIA storage device 20 in the event that the store computer 26 is unable to write the transaction record to the customer local EIA storage device 20. In addition, the archiving of transaction records may be used to recover from hardware failure of the customer local EIA storage device 20.

Conversely, the local EIA storage device 20 may advantageously store transaction records until such time as the remote EIA storage device 22 may be synchronized. For instance, the customer 16 may engage in a transaction with the non-networked, off-line store computer 28 that has a communication link 32 for reading from and writing to the customer local EIA storage device 20. The locally stored transaction record may then be “uploaded”, or electronically communicated, to synchronize the remote EIA storage device 22 during a subsequent transaction at the networked off-line store computer 26 or on a communication link 34 of the customer computer 12. Depending upon the type of customer EIA local storage device, the communication links 32, 34 may be magnetic card readers, memory stick reader, PC parallel ports, infrared serial communication link, wireless telephone data modem, etc. The EIA may further be affiliated with a financial account issued by a financial institution computer 36 to effect payment, in addition to providing identifying information and storing transaction records.

With reference to both FIGS. 1 and 2, the customer computer 12, which may be similar to computers 18, 24, 26, 28, 30, 36, may include a central processing unit (CPU), or microprocessor (“processor”) 38; a memory 39, a number of peripheral components coupled to the processor 38 such as a computer display 40 (e.g., a CRT monitor, an LCD display panel, and/or a speaker, among others); a mass storage device 42; and various user input devices 44 (e.g., a mouse 46 and a keyboard 48), among others (e.g., trackball, a joystick, a touchpad, and/or a microphone). The processor 38 communicates with the customer EIA local storage device 20 via the communication link 34, depicted in FIG. 2 as comprised of both an EIA local storage writer 50 and reader 52.

The processor 38 of the customer computer 12 accesses the on-line retail computer 24, the EIA facilitator 18, the manufacturer computer 30 and the remote EIA storage device 22 over network 14 via a network interface 54. In particular, the processor 38 accesses an application 56, such as a browser, stored in memory 39 and displayed to the customer as a window 58 on the computer display 40. The application 56 is executed by the processor 58 in accordance with an operating system 59 resident in memory 39. The window 58 is a rendering of a web page 60 from the World Wide Web, provided over the network 14 as a hypertext markup language (HTML), or hypertext, document from a selected computer. The customer 16 interacts with the web page 60 by manipulating a cursor 62 controlled by the mouse 46.

Memory 39 may represent random access memory (RAM) devices comprising the main storage of computer 12, as well as any supplemental levels of memory, e.g., cache memories, non-volatile or backup memories (e.g., programmable or flash memories), read-only memories, etc. In addition, memory 39 may be considered to include memory storage physically located elsewhere in computer 12, e.g., any cache memory in a processor 38, as well as any storage capacity used as a virtual memory, e.g., as stored on the mass storage device 42 or on another computer coupled to computer 12 via the network 14.

For additional storage, computer 12 may also include one or more mass storage devices 42, e.g., a floppy or other removable disk drive, a hard disk drive, a direct access storage device (DASD), an optical drive (e.g., a CD drive, a DVD drive, etc.), and/or a tape drive, among others. Furthermore, the network interface 54 of the computer 12 may include an interface with one or more networks (e.g., a LAN, a WAN, a wireless network, and/or the Internet, among others) to permit the communication of information with other computers coupled to the network 14. It should be appreciated that computer 12 typically includes suitable analog and/or digital interfaces between processor 38 and each of components, as is well known in the art.

In general, the routines executed to implement the embodiments of the invention, whether implemented as part of an operating system or a specific application, component, program, object, module or sequence of instructions will be referred to herein as “computer programs”, or simply “programs”. The computer programs typically comprise one or more instructions that are resident at various times in various memory and storage devices in a computer, and that, when read and executed by one or more processors in a computer, cause that computer to perform the steps necessary to execute steps or elements embodying the various aspects of the invention. Moreover, while the invention has and hereinafter will be described in the context of fully functioning computers and computer systems, those skilled in the art will appreciate that the various embodiments of the invention are capable of being distributed as a program product in a variety of forms, and that the invention applies equally regardless of the particular type of signal bearing media used to actually carry out the distribution. Examples of signal bearing media include but are not limited to recordable type media, such as volatile and non-volatile memory devices, floppy and other removable disks, hard disk drives, magnetic tape, optical disks (e.g., CD-ROMs, DVDs, etc.), among others, and transmission type media such as digital and analog communication links.

In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Those skilled in the art will recognize that the exemplary environments illustrated in FIGS. 1 and 2 are not intended to limit the present invention. Indeed, those skilled in the art will recognize that other alternative hardware and/or software environments may be used without departing from the scope of the invention.

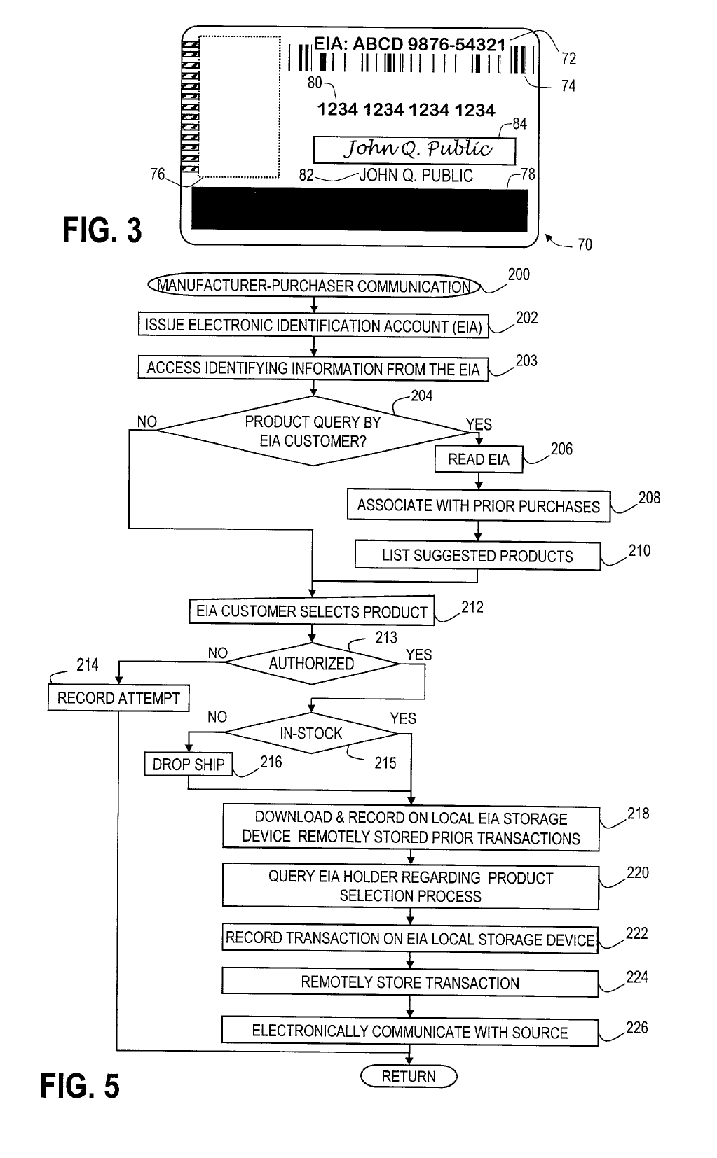

With reference to FIG. 3, an illustrative example of a customer EIA local storage device 20 is depicted as an EIA smart card 70. The identifying information about the customer 16 may be obtained in various ways: manually entering an EIC customer number 72 printed on the card 70, scanning an EIC barcode 74, electrically connecting to a nonvolatile memory 76, and/or reading a magnetic strip 78. The nonvolatile memory 76 advantageously includes storage for a customer profile and transaction records. Using the EIA customer number only would generally access the remote EIA storage device 22. The EIA smart card 70 is illustrated also serving as a credit card by bearing a credit card number 80, printed customer name 82, and signature block 84.

An alternative example of a local storage device 22 is a portable electronic device with a memory and a display (not shown). For example, a PDA may display the EIA customer number and/or bar code and be capable of serial or parallel digital communication via electrical cable or infrared link. A further alternative includes a memory stick, flash memory cord, floppy disk, or other forms of nonvolatile memory (not shown). The off-line store computer 28 would include an interface to access the memory.

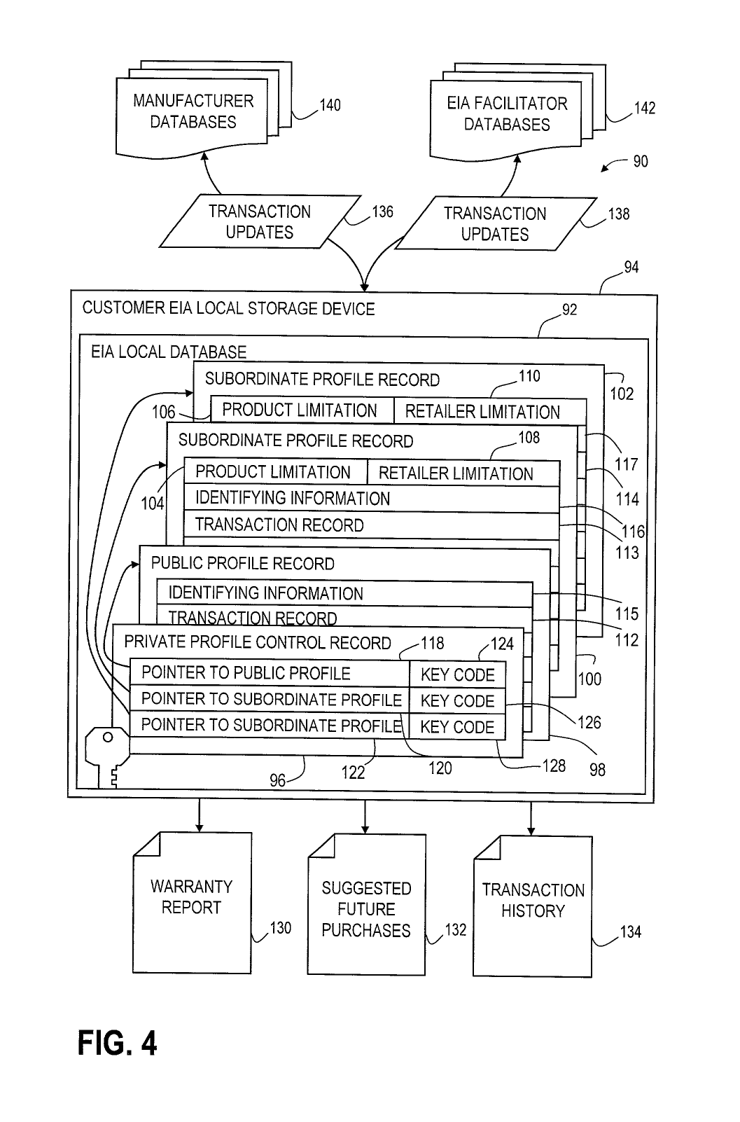

With reference to FIG. 4, a data structure 90 for the computer system 10 illustrates an EIA local data base 92 which is stored on a customer EIA local storage device 94. The local data base 92 has a key encrypted private profile control record 96 that enables creation and modification of a public profile record 98 and subordinate profile records 100, 102. Thus, a customer 16 is able to perform modifications to subordinate profiles 100, 102, such as adding product limitations 104, 106 and retailer limitations 108, 110. The customer 16 may also access transaction records 112-114 for each profile 98-102. The customer 16 may also add and modify identifying information records 115-117 for respective public profiles 98-102 for purposes such as expediting retail purchases and product registrations. Examples of identifying information contained in records 115-117 include legal name, residential delivery and mailing addresses, telephone numbers, social security number, drivers license state and number, assigned manufacturer customer number, etc. The private profile control record 96 links to the profiles 98-102 via respective pointers 118-122, each enabled by a key code 124-128.

It will be appreciated that applications consistent with aspects of the invention will include privacy protections for the identifying information. For example, a personal identification number (PIN) for the entire database 92 or for an individual public profile record 98-102 may be required to access the identifying information. Thus, a lost or stolen customer EIA local storage device 94 is not compromised.

It will be further appreciated that applications consistent with aspects of the invention may include only one subordinate profile record 100 and no public profile record 98. For example, a user may have a different storage device 94 for each assigned EIA. Moreover, the subordinate profile record 100 may be controlled or uncontrolled. For example, the subordinate profile record 100 may be intended for a minor child and have limitations imposed on usage. As a further example, the user may wish to impose limitations to prevent abuse of the storage device 94 if lost or stolen.

The data base 92 provides information to the customer 16, depicted as a warranty report 130, a suggested future purchases report 132, and a transaction history report 134. In some applications, a store computer 28 is allowed to generate these reports at the behest of the customer 16. These reports 130-134 may be electronically communicated as respective transaction updates 136, 138 to manufacturer databases 140 and EIA facilitator databases 142, the latter supporting the remote EIA storage device 22.

The transaction updates 136, 138 to the EIA facilitator database 142 may comprise a full archiving of information stored on the customer EIA local storage device 94. Alternatively, the EIA facilitator database 142 may store only a portion of the information. For instance, a user may restrict data deemed private that is not to be remotely stored. Similarly, transaction updates 138 may be summary in nature in order to reduce the required communication and remote storage overhead required. For example, this limitation may be appropriate for remote storage that is directed to data mining rather than to archival purposes for the user. Also, the remote storage may be time stamped such that older information is periodically purged.

With reference to FIG. 5, a sequence of events, depicted as a routine 200 for manufacturer-purchaser communication, is performed by the computer system 10 of FIG. 1. Routine 100 illustrates advantages of the EIA to facilitate a purchase transaction between a merchant and a customer. Furthermore, the EIA benefits a manufacturer of a product purchased by the customer either on-line or off-line as well as benefitting the customer. Routine 100 illustrates execution of a program that resides on the computer system 10 for supporting one or more EIA's assigned to various clients. For instance, the routine 100 may be accessed by store computers 26, 28 or on-line retailer computer 24 during a transaction.

First, in block 202 the EIA is issued. For instance, at the time of the first purchase of a product from a specific manufacturer made from any available point of presence (e.g., on-line, off-line store, mail or telephone order), the EIA is created by an EIA facilitator, which may be the manufacturer or be a separate entity that services a number of manufacturers. The EIA may be communicated to the customer for use as a customer EIA local storage device by downloading a program onto a portable electronic device or by mailing a smart card or by other suitable device.

After receipt of the local storage device, the customer may present the EIA to a merchant or manufacturer for assistance in selecting a product for purchase. The merchant or manufacturer accesses the public profile on the device to ascertain identifying information for the user (block 203). This identification may include intrinsic safeguards, such as user or merchant supplied access codes or PIN. This identification may include extrinsic safeguards, such as a procedure to verify the identifying information against printed information on the device or on another form of identification. As one use, the customer may thereafter seek guidance as to products compatible with those previously purchased. In this instance, a product query is made (block 204), and the EIA is read from the EIA local storage device or the remote EIA storage device (block 206). Recorded transaction records of the EIA are associated with the query and with the merchant's listing of available products (block 208). Then, suggested products for purchase are listed for the customer (block 210).

If no query of the above-described kind is made in block 204, or after listing products in block 210, the customer selects a product for purchase (block 212). The merchant or manufacturer verifies that the EIA authorizes the selected purchase (block 213), and, if not, the purchase attempt is recorded at one or more locations such as in a transaction record that is locally or remotely stored (block 214). If authorized in block 213, then a determination is made as to whether the product is available in stock (block 215). If not, then a back order is made, if desired, to drop ship the product at a later time (block 216). If the product is in stock in block 215, then an opportunity is taken to update the EIA, either on the local storage device and/or the remote storage device. In particular, archived prior transaction records that are remotely stored are downloaded and recorded on the local EIA storage device (block 218). Advantageously, the merchant may query the EIA holder regarding their product selection process (e.g., web sites consulted, effect of advertisements and purchase inducements, etc.) (block 220). If the customer provides this information either verbally or enters the data into a webpage template, the data is also recorded on the EIA local storage device along with the other information about the transaction (block 222). If available, the transaction record is also stored remotely for archive purposes (block 224). Then, specific transaction information is electronically communicated with the source of the product, such as the manufacturer (block 226). After block 214 or 226, the routine 200 returns for additional transactions.

In use, an EIA is established for a customer 16 and stored on a local storage device 20, such as smart card 70 or a PDA. The customer 16 uses the local storage device 20 during an off-line purchase at a store computer 26, 28 or on-line via a customer computer 12. The EIA includes a public profile record 98 with identifying information that facilitates the purchase, allowing electronic communication of warranty registration and enabling electronic communication of the transaction for purchase incentives, or other uses. In addition, the EIA includes transaction records of prior purchases enabling suggestions to be made for future purchases, such as identifying specific part numbers and sources for frequently used products. The customer 16 gains additional control over their private information contained in the EIA yet benefits from the convenience of electronic communication of selected information. Furthermore, the EIA may include controlled accounts wherein the customer 16 may limit purchases by retailer or by product to prevent inadvertent or undesired usage.

By virtue of the foregoing, an EIA stored on a customer EIA local storage device 20 facilitates purchase transactions by electronically communicating identifying information to a merchant about the customer and by storing past transaction records. Moreover, the EIA facilitates the transaction both in off-line as well as on-line transactions and encourages beneficial relationships between the customer and the source of products purchased.

While the present invention has been illustrated by a description of various embodiments and while these embodiments have been described in considerable detail, it is not the intention of the applicants to restrict or in any way limit the scope of the appended claims to such detail. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit or scope of applicant's general inventive concept.

What is claimed is:

1. A method of facilitating a transaction between a merchant and a customer with a customer data storage device, the method comprising:
electronically storing a customer profile on the customer data storage device;
electronically communicating the customer profile from the customer data storage device to the merchant in conjunction with the transaction; and
electronically storing a record of the transaction on the customer data storage device.

2. The method of claim 1, wherein the transaction comprises a retail purchase of a product, the method further comprising:
electronically communicating data regarding the transaction to a source of the product.

3. The method of claim 2, wherein electronically communicating data regarding the transaction to the source of the product comprises electronically communicating customer and product identification for product registration.

4. The method of claim 1, wherein the customer data storage device comprises a card bearing a magnetic recording medium, and wherein electronically storing to the customer data storage device comprises writing digital data to the magnetic storage medium.

5. The method of claim 1, wherein the customer data storage device comprises a portable electronic device having memory and a communication link, and wherein electronically storing to the customer data storage device comprises writing digital data to the memory via the communication link.

6. The method of claim 1, wherein electronically storing a customer profile further comprises storing at least one of a grouping consisting of a name, a residential address, and an identification number.

7. The method of claim 1, further comprising:
reading the transaction record on the customer data storage device; and
reporting the transaction record.

8. The method of claim 7, wherein the customer data storage device includes a plurality of transaction records, the method further comprising:
analyzing the plurality of transaction records for a pattern of customer preferences; and
recommending a future transaction based on the pattern of customer preferences.

9. The method of claim 1, further comprising:
remotely maintaining at least a portion of the customer profile and database of transaction records associated with the customer profile on the customer data storage device; and
synchronizing the database of transaction records with the customer data storage device in response to subsequent availability of electronic communication between the database and the storage device after an intervening transaction wherein a transaction record was stored on only one of the database and the storage device.

10. A method of affecting purchase transactions of a subordinate person with a customer data storage device, the method comprising:
storing a controlled customer profile on the customer data storage device;
associating a financial credit identifier with the controlled customer profile;
electronically communicating the transaction limitation from the customer data storage device to the merchant; and
preventing authorization of the purchase transaction based on the transaction limitation.

11. The method of claim 10, further comprising:
storing a transaction limitation in the controlled customer profile.

12. The method of claim 10, wherein electronically communicating the transaction limitation from the customer data storage device to the merchant is in response to presenting the financial credit identifier for a purchase transaction.

13. The method of claim 10, wherein storing the transaction limitation further comprises specifying an excluded merchant that is not authorized for purchase transactions.

14. The method of claim 10, wherein storing the transaction limitation further comprises specifying an included merchant that is authorized for purchase transactions.

15. The method of claim 10, wherein storing the transaction limitation further comprises specifying an excluded product that is not authorized for purchase transactions.

16. The method of claim 10, wherein storing the transaction limitation further comprises specifying an included product that is authorized for purchase transactions.

17. The method of claim 10, further comprising:
locking the controlled customer profile on the customer storage device;
unlocking the controlled customer profile in response to satisfaction of an access criterion; and
modifying the transaction limitation after unlocking the customer profile.

18. The method of claim 10, wherein the access criterion is an encryption key and locking the controlled customer profile comprises encrypting the controlled customer profile with the encryption key.
